(19) United States
(12) Patent Application Publication
(10) Pub. No.: US 2026/0158876 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventor: Seong-Bin Jeong, Hwaseong-si (KR)

(73) Assignees: HYUNDAI MOTOR COMPANY, Seoul (KR); KIA CORPORATION, Seoul (KR)

(21) Appl. No.: 19/256,873

(22) Filed: Jul. 1, 2025

(30) Foreign Application Priority Data
Dec. 6, 2024 (KR) 10-2024-0181000

(51) Int. Cl. B60H 1/32; B60H 1/00

(52) U.S. Cl. CPC B60H 1/32284; B60H 1/00278; B60H 1/00485

(57) ABSTRACT

A heat pump system for a vehicle is capable of adjusting the temperature of the battery module by using a single chiller in which a normal coolant and a low-conductivity coolant having different properties are heat-exchanged with each other. The heat pump system is further capable of decreasing the manufacturing cost as well as improving the fire stability of the battery module by employing a separate battery cooling apparatus for circulating the low-conductivity coolant through a high-voltage battery module.

### CROSS-REFERENCE TO RELATED APPLICATION

This application claims priority to and the benefit of Korean Patent Application No. 10-2024-0181000, filed with the Korean Intellectual Property Office on Dec. 6, 2024, the entire contents of which is incorporated herein by reference.

### FIELD

The present disclosure relates to a heat pump system for a vehicle, and more particularly, the present disclosure relates to a heat pump system for a vehicle capable of stably adjusting the temperature of the battery module.

### BACKGROUND

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

Among these, electric vehicles are attracting attention as a future means of transportation to solve environmental and energy resource problems.

These environment-friendly vehicles are equipped with a heat pump system, which is an air-conditioner apparatus for adjusting the vehicle interior temperature.

The electric vehicle generates driving force by converting chemical reaction energy between oxygen and hydrogen into electrical energy, and in this process, heat energy is generated by a chemical reaction in a fuel cell. Therefore, it is necessary in securing performance of the fuel cell to effectively remove generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in the hybrid vehicle or the electric vehicle according to the related art, cooling means, a heat pump system, and a battery cooling system, each should be configured as separate closed circuits so as to prevent heat generation of the motor, an electric component, and the battery including a fuel cell.

Therefore, there is a disadvantage in that the size and weight of the cooling module disposed at the front of the vehicle increase, and the layout of the connecting pipes that supply refrigerant or cooling water to each device within a narrow space becomes complicated.

In addition, since a battery cooling apparatus for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort.

A water-cooled cooling system using coolant has been applied to improve the cooling efficiency of batteries. However, in a water-cooled cooling system using a general coolant, an electrical short may occur as the coolant circulates through the battery where high voltage is generated.

If an electrical short circuit occurs in a battery, a fire may occur in a high-voltage battery.

The above information disclosed in this Background section is only to enhance understanding of the background of the disclosure, and therefore it may contain information that does not form the prior art that is already known to one having ordinary skill in the art.

### SUMMARY

The present disclosure provides a heat pump system for a vehicle capable of adjusting the temperature of the battery module by using a single chiller in which a normal coolant and a low-conductivity coolant having different properties are heat-exchanged with each other, and suppressing the increase of the manufacturing cost as well as improving the fire stability of the battery module by employing a separate battery cooling apparatus for circulating the low-conductivity coolant through a high-voltage battery module.

In addition, according to the present disclosure, a heat pump system for a vehicle capable of simplifying the layout of the system and reducing the manufacturing cost by forming a plurality of fluid lines in a single valve through which the coolant flows depending on a selected mode of a vehicle.

In an embodiment of the present disclosure, a heat pump system for a vehicle includes a valve module configured to control a flow rate of a first coolant based on at least one mode for adjusting a temperature of a vehicle interior and for adjusting a temperature of an electrical component and a battery module. The heat pump system further includes a first line connected to the valve module to selectively allow the first coolant to flow, and on which the electrical component is provided. The heat pump system further includes a second line including a first end connected to the first line, a second end connected to the valve module to selectively allow the first coolant to flow, and on which a radiator is provided. The heat pump system further includes a third line connected to the valve module to selectively allow the first coolant to flow, and on which a temperature adjusting module is provided. The heat pump system further includes a fourth line having a first end connected to the valve module so as to selectively allow the first coolant to flow, and a second end connected to the third line. The heat pump system further includes a fifth line having a first end connected to the valve module to selectively allow the first coolant to flow. The heat pump system further includes a sixth line having a first end connected to a location where the first line and the second line are connected, and selectively allowing the first coolant to flow. The heat pump system further includes a seventh line having a first end connected to a location where the third line and the fourth line are connected, and selectively allowing the first coolant to flow. The heat pump system further includes a battery cooling apparatus including a battery coolant line having a first end and a second end connected to the temperature adjusting module to allow a second coolant to flow, and the battery module provided on the battery coolant line.

The temperature adjusting module may include a first chiller respectively connected to the third line and the battery coolant line so as to allow the first coolant and the second coolant to flow respectively, a coolant heater connected to the battery coolant line to allow the second coolant to flow, and configured to selectively heat the second coolant, and a first water pump provided on the battery coolant line so that the second coolant circulates along the battery coolant line.

The first chiller, the coolant heater, and the first water pump may be integrally configured.

The valve module may include a valve configured to control the flow rate of the first coolant, and at least one water pump provided in the valve.

The at least one water pump may include a second water pump mounted on the valve to correspond to the first line, and a third water pump mounted on the valve to correspond to the third line.

The second water pump and the third water pump may be disposed at locations facing each other based on the valve.

The valve may be configured to selectively discharge the first coolant selectively introduced from the second line, the fourth line, or the fifth line through the first line or the third line, based on the selected at least one mode.

A second chiller connected to an air conditioner unit through a refrigerant connection line may be provided at a second end of the fifth line, and a second end of the sixth line and a second end of the seventh line are respectively connected to the second chiller, so that the sixth line and the seventh line are connected to the fifth line through the second chiller.

The second chiller may be a water-cooled heat-exchanger configured to heat-exchange the first coolant with the refrigerant supplied from the air conditioner unit.

The at least one mode may include a first mode for cooling the electrical component by using the first coolant cooled in the radiator, and for cooling the battery module, a second mode for cooling the vehicle interior, and for cooling the battery module, a third mode for heating the vehicle interior, and for heating the battery module by using a coolant heater, and a fourth mode for heating the vehicle interior, and for heating the battery module by using the second coolant heat-exchanged with the first coolant.

In the first mode, the second line may be connected to the third line by the valve module so that the first coolant cooled in the radiator is supplied into the electrical component and the temperature adjusting module. The fourth line is connected to the first line by an operation of the valve module. The first line, the second line, the third line, and the fourth line are interconnected by the valve module, so that the first coolant circulates along the first line, the second line, the third line, and the fourth line. The fifth line may be closed by the valve module. The sixth line and the seventh line may be closed. The second coolant flows along the battery coolant line by the temperature adjusting module, in the battery cooling apparatus. The temperature adjusting module may heat-exchange the first coolant flowing from the radiator along the third line with the second coolant flowing along the battery coolant line, and may supply the heat-exchanged second coolant to the battery module through the battery coolant line. In the first mode, the air conditioner unit may be configured to be stopped.

In the second mode, the second line may be connected to the first line by an operation of the valve module so that the first coolant cooled in the radiator is supplied to the electrical component. The fifth line is connected to the third line by the operation of the valve module. The seventh line is opened, so that the third line and the fifth line are connected. The fourth line may be closed by the operation of the valve module. The sixth line may be closed. The first line and the second line form an independent closed circuit by the valve module. The third line, the fifth line, and the seventh line form an independent closed circuit by the operation of the valve module. The second coolant flows along the battery coolant line by the temperature adjusting module, in the battery cooling apparatus. The temperature adjusting module may heat-exchange the first coolant flowing along the third line with the second coolant flowing along the battery coolant line, and may supply the heat-exchanged second coolant to the battery module through the battery coolant line.

In the third mode, the second line may be closed by the valve module so that the first coolant having passed through the electrical component is not supplied to the radiator. The third line and the fourth line may be closed by the valve module. The fifth line is connected to the first line by the valve module. The sixth line is opened to be connected to the first line and the fifth line. The seventh line may be closed. The first line, the fifth line, and the sixth line form an independent closed circuit by the valve module. The second coolant flows along the battery coolant line by the temperature adjusting module, in the battery cooling apparatus. The temperature adjusting module increases the temperature of the second coolant flowing along the battery coolant line, and may supply the second coolant whose temperature is increased to the battery module through the battery coolant line.

In the fourth mode, the second line may be closed by the valve module so that the first coolant having passed through the electrical component is not supplied to the radiator. The fourth line may be closed by the valve module. The fifth line is connected to the first line and the third line by the valve module. The sixth line is opened to be connected to the first line and the fifth line. The seventh line is opened to be connected to the third line and the fifth line. The first line, the third line, the fifth line, the sixth line, and the seventh line are interconnected by the valve module. A partial first coolant among the first coolant introduced into the valve module through the fifth line flows to the first line. A remaining first coolant among the first coolant introduced into the valve module through the fifth line flows to the third line. The second coolant flows along the battery coolant line by the temperature adjusting module, in the battery cooling apparatus. The temperature adjusting module may heat-exchange the first coolant flowing along the third line with the second coolant flowing along the battery coolant line, and may supply the heat-exchanged second coolant to the battery module through the battery coolant line.

The valve module may further include a reservoir tank provided in the valve and connected to the second line.

When the temperature of the battery module is to be increased, the coolant heater is operated to heat the second coolant supplied to the battery module along the battery coolant line.

The second coolant may be a low-conductivity coolant having low electrical conductivity.

The first coolant and the second coolant may be different coolants.

As described above, according to a heat pump system for a vehicle according to an embodiment of the present disclosure, the temperature of the battery module can be adjusted by using a chiller in which the normal coolant and the low-conductivity coolant having different properties are heat-exchanged with each other, and by employing a separate battery cooling apparatus for circulating the low-conductivity coolant through a high-voltage battery module, the fire safety of the battery module may be improved.

In addition, according to the present disclosure, by applying both of a normal coolant for adjusting the temperature of the electrical component and a low-conductivity coolant for adjusting the temperature of the battery module, the fire safety of the battery module may be secured, thereby enabling compliance with coolant regulation and minimizing cost increases.

In addition, according to the present disclosure, a plurality of fluid lines through which the coolant flows depending on a selected mode of a vehicle may be formed in a single valve, and the components are modularized, thereby achieving streamlining and simplification of the system.

In addition, according to the present disclosure, by efficiently adjusting the temperature of the battery module, the optimal performance of the battery module may be achieved, and the overall travel distance of the vehicle may be increased through the efficient management of the battery module.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode in a heat pump system for a vehicle according to an embodiment of the present disclosure.

FIG. 3 is an operation diagram according to a second mode in a heat pump system for a vehicle according to an embodiment of the present disclosure.

FIG. 4 is an operation diagram according to a third mode in a heat pump system for a vehicle according to an embodiment of the present disclosure.

FIG. 5 is an operation diagram according to a fourth mode in a heat pump system for a vehicle according to an embodiment of the present disclosure.

The drawings described herein are for illustration purposes only and are not intended to limit the scope of the present disclosure in any way.

### DETAILED DESCRIPTION

Embodiments of the present disclosure are hereinafter described in detail with reference to the accompanying drawings.

It should be understood that the description and specific embodiments are intended for purposes of illustration only and are not intended to limit the scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise” and variations such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

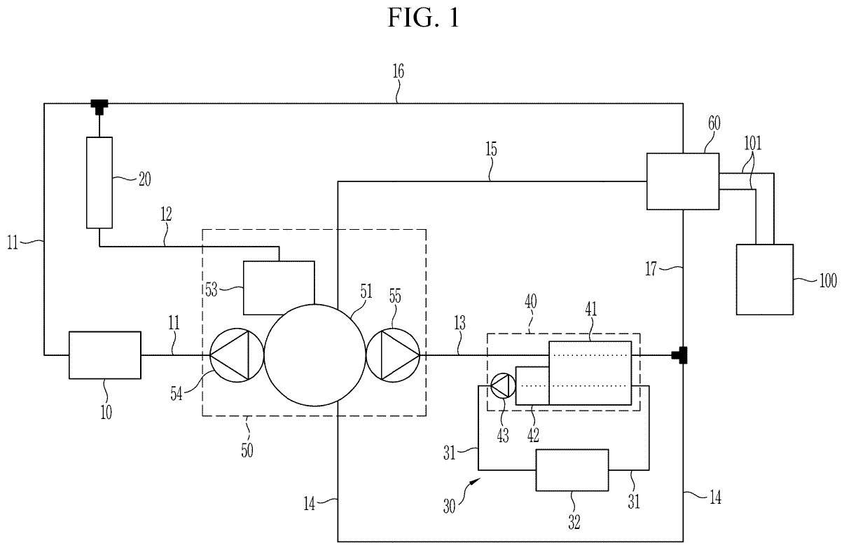

FIG. 1 is a block diagram of a heat pump system for a vehicle according to an embodiment of the present disclosure.

According to an embodiment of the present disclosure, a heat pump system for the vehicle may adjust a temperature of a battery module 32 by using a single chiller in which a first coolant and a second coolant having different properties exchange heat, and employ a separate battery cooling apparatus 30 for circulating the second coolant through the high-voltage battery module 32, so as to suppress the increase of the manufacturing cost and at the same time, improve the fire stability of the battery module 32.

In addition, according to the present disclosure, by forming a plurality of fluid lines in a single valve 51 through which the first coolant flows based on the selected mode of the vehicle, the layout of the entire system may be simplified and the manufacturing cost may be reduced.

In the heat pump system, the electrical component 10 through which the first coolant flows may be linked with an air conditioner unit 100 for circulating a refrigerant in order to cool and heat a vehicle interior, through a second chiller 60.

In other words, referring to FIG. 1, the heat pump system may include a first line 11, a second line 12, a third line 13, a fourth line 14, a fifth line 15, a sixth line 16, a seventh line 17, the battery cooling apparatus 30, a valve module 50, and the second chiller 60.

The valve module 50 may control the flow of the interiorly introduced first coolant based on at least one selected mode for adjusting a temperature of a vehicle interior, and for adjusting a temperature of the electrical component 10 and the battery module 32.

In other words, the first coolant may flow through a selected line among the first to the seventh lines 11, 12, 13, 14, 15, 16, and 17 the valve module 50.

A detailed configuration of the valve module 50 is described in detail hereinbelow.

In an embodiment of the present disclosure, a first end of the first line 11 may be connected to the valve module 50, and the first coolant may selectively flow therethrough. The electrical component 10 may be provided on the first line 11.

A first end of the second line 12 may be connected to a second end of the first line 11. A second end of the second line 12 may be connected to the valve module 50, and the first coolant may selectively flow therethrough.

A radiator 20 may be provided on the second line 12. The radiator 20 may be disposed at the front of the vehicle, and a cooling fan (not shown) may be provided on a downstream side of the radiator 20. Accordingly, the radiator 20 may cool the first coolant through an operation of the cooling fan and heat-exchange with an ambient air.

In an embodiment of the present disclosure, a first end of the third line 13 may be connected to the valve module 50 to selectively allow the first coolant to flow. A temperature adjusting module 40 included in the battery cooling apparatus 30 may be provided on the third line 13.

A first end of the fourth line 14 may be connected to the valve module 50 to selectively allow the first coolant to flow. A second end of the fourth line 14 may be connected to a second end of the third line 13.

In an embodiment of the present disclosure, a first end of the fifth line 15 may be connected to the valve module 50 to selectively allow the first coolant to flow. The second chiller 60 may be provided on a second end of the fifth line 15.

The second chiller 60 may be connected to the air conditioner unit 100 through a refrigerant connection line 101. The second chiller 60 may be a water-cooled heat-exchanger configured to heat-exchange the interiorly introduced first coolant with the refrigerant supplied from the air conditioner unit 100.

In other words, the second chiller 60 may adjust the temperature of the first coolant by heat-exchanging the selectively supplied first coolant with the refrigerant selectively supplied from the air conditioner unit 100.

When cooling the first coolant, or at the time of heating of the vehicle interior, the second chiller 60 may be operated in order to recollect heat from the first coolant whose temperature is increased by a waste heat of the electrical component 10.

In an embodiment of the present disclosure, a first end of the sixth line 16 may be connected to a location where the first line 11 and the second line 12 are connected. The first coolant may selectively flow along the sixth line 16 configured as such according to an operation of the valve module 50.

In addition, a first end of the seventh line 17 may be connected to a location where the third line 13 and the fourth line 14 are connected. The first coolant may selectively flow along the seventh line 17 configured as such according to the operation of the valve module 50.

A second end of the sixth line 16 and a second end of the seventh line 17 may be respectively connected to the second chiller 60 so that the sixth line 16 and the seventh line 17 are connected to the fifth line 15 through the second chiller 60.

In an embodiment of the present disclosure, the battery cooling apparatus 30 may include a battery coolant line 31 having a first end and a second end connected to the temperature adjusting module 40 to allow the second coolant to flow, and the battery module 32 provided on the battery coolant line 31.

The second coolant may be a low-conductivity coolant.

The low-conductivity coolant is a coolant preventing electrically short-circuiting, and may be applied to prevent an electrical short-circuiting while cooling the high-voltage battery module 32.

As such, the second coolant configured as the low-conductivity coolant may safely cool the battery module 32 without electrical short-circuiting.

The temperature adjusting module 40 may include a first chiller 41, a coolant heater 42, and a first water pump 43.

The first chiller 41 may be connected to the third line 13 and the battery coolant line 31 so that the first coolant and the second coolant each internally flow.

The first chiller 41 may adjust the temperature of the second coolant by heat-exchanging the first coolant and the second coolant with each other.

The coolant heater 42 may be configured on a first side of the first chiller 41. The coolant heater 42 may be connected to the battery coolant line 31 to allow the second coolant to flow, and may selectively heat the second coolant.

In other words, when the temperature of the battery module 32 is to be increased by using the second coolant, the coolant heater 42 may be operated to heat the second coolant supplied to the battery module 32 along the battery coolant line 31.

The coolant heater 42 may be an electrical heater operating according to supply of power.

In other words, the coolant heater 42 may be operated when the temperature of the second coolant supplied to the battery module 32 is lower than a target temperature, to heat the second coolant flowing along the battery coolant line 31.

Accordingly, the second coolant whose temperature is increased while passing through the coolant heater 42 may be supplied to the battery module 32 along the battery coolant line 31 by the temperature adjusting module 40, and may increase the temperature of the battery module 32.

Therefore, the coolant heater 42 may selectively operate when the temperature of the battery module 32 is to be increased.

In addition, the first water pump 43 may be provided on the battery coolant line 31 so that the second coolant circulates along the battery coolant line 31.

The first chiller 41, the coolant heater 42, and the first water pump 43 may be integrally configured to form a single module.

An embodiment of the present disclosure takes an example in which the second chiller 60 connected to the air conditioner unit 100 through the refrigerant connection line 101 is provided on the fifth line 15, and respectively connected to the sixth line 16 and the seventh line 17, so that the first coolant and the refrigerant may be heat-exchanged with each other, but it is not limited thereto.

In other words, the second chiller 60 may be provided on the battery coolant line 31 to heat-exchange the second coolant with the refrigerant, and may be included in the temperature adjusting module 40.

As such, when the second chiller 60 is included in the temperature adjusting module 40, the second chiller 60 may be integrally configured with the first chiller 41.

In addition, the valve module 50 may include the valve 51 configured to control the flow of the interiorly introduced first coolant, and at least one water pump provided in the valve 51.

The valve module 50 may further include a reservoir tank 53 provided in the valve 51 and connected to the second line 12.

The at least one water pump may include second and third water pumps 54 and 55.

The second water pump 54 may be mounted on the valve 51 to correspond to the first line 11.

In addition, the third water pump 55 may be mounted on the valve 51 to correspond to the third line 13.

The second water pump 54 and the third water pump 55 may be disposed at locations facing each other based on the valve 51.

In an embodiment of the present disclosure, depending on the selected at least one mode, the valve 51 may selectively discharge the first coolant selectively introduced from the second line 12, the fourth line 14, or the fifth line 15 through the first line 11 or the third line 13.

The at least one mode may include a first mode to a fourth mode.

In the first mode, the electrical component 10 may be cooled by using the first coolant cooled in the radiator 20, and the battery module 32 may be cooled by using the second coolant heat-exchanged with the first coolant.

In a second mode, the vehicle interior may be cooled, and the battery module 32 may be cooled.

In a third mode, the vehicle interior may be heated, and the battery module 32 may be heated by using the coolant heater 42.

In addition, in the fourth mode, the vehicle interior may be heated, and the battery module 32 may be heated by using the second coolant heat-exchanged with the first coolant.

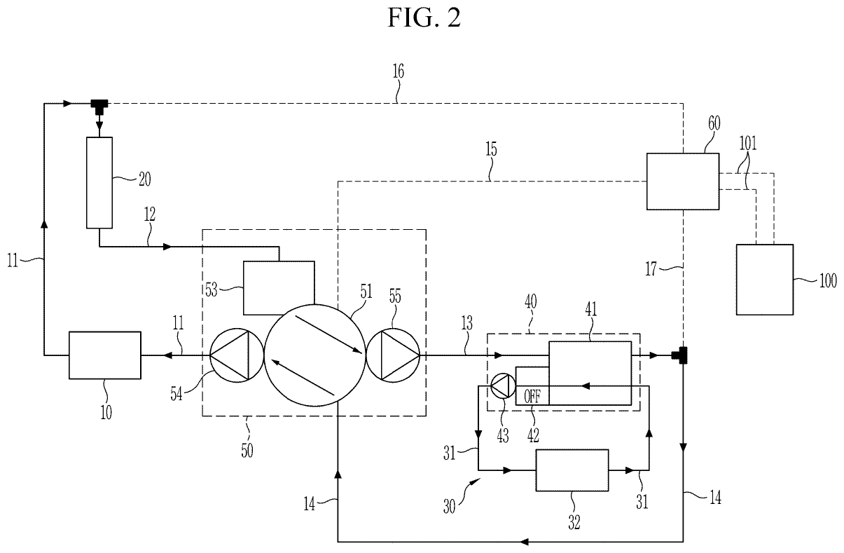

Hereinafter, an operation and action for each mode of a heat pump system for the vehicle according to an embodiment of the present disclosure configured as described above are described in detail with reference to FIGS. 2-5.

In a heat pump system for the vehicle according to an embodiment of the present disclosure, an operation in the first mode for cooling the electrical component 10 by using the first coolant cooled in the radiator 20, and for cooling the battery module 32 by using the second coolant heat-exchanged with the first coolant is described in detail with reference to FIG. 2.

FIG. 2 is an operation diagram according to the first mode in a heat pump system for the vehicle according to an embodiment of the present disclosure.

Referring to FIG. 2, in the first mode, the second line 12 may be connected to the third line 13 by an operation of the valve 51 so that the first coolant cooled in the radiator 20 is supplied into the electrical component 10 and the temperature adjusting module 40.

The fourth line 14 may be connected to the first line 11 by the operation of the valve 51.

The fifth line 15 may be closed by the operation of the valve 51. The sixth line 16 and the seventh line 17 may be closed by the closed fifth line 15.

Accordingly, the first line 11, the second line 12, the third line 13, and the fourth line 14 may be interconnected by the operation of the valve 51, so that the first coolant circulates along the first line 11, the second line 12, the third line 13, and the fourth line 14.

In such a state, when the second water pump 54 and the third water pump 55 are each operated, the first coolant cooled in the radiator 20 may be introduced into the valve 51 along the second line 12, and then discharged through the third line 13.

The first coolant discharged to the third line 13 may pass through the first chiller 41 provided on the temperature adjusting module 40.

In the battery cooling apparatus 30, the second coolant may flow along the battery coolant line 31 by an operation of the first water pump 43, and may pass through the first chiller 41.

Accordingly, the first coolant may cool the second coolant through heat-exchange with the second coolant passing through the first chiller 41.

The second coolant cooled in the first chiller 41 through heat-exchange with the first coolant may flow along the battery coolant line 31, and the battery module 32 may be efficiently cooled while passing through the battery module 32.

The second coolant having passed through the battery module 32 may pass through the first chiller 41 again along the battery coolant line 31, thereby repeatedly performing the above-described operation.

The first coolant having passed through the first chiller 41 may be introduced back into the valve 51 along the fourth line 14.

The first coolant introduced into the valve 51 along the fourth line 14 may be discharged through the first line 11.

The first coolant discharged to the first line 11 may cool the electrical component 10 while passing through the electrical component 10. The first coolant having cooled the electrical component 10 may be introduced into the radiator 20 along the second line 12.

The first coolant introduced into the radiator 20 may be cooled through heat-exchange with the ambient air.

The operation of the air conditioner unit 100 may be stopped.

In other words, while repeatedly performing the above-described processes, the first coolant cooled in the radiator 20 may cool the electrical component 10 to prevent overheating, and may cool the second coolant passing through the first chiller 41.

In addition, the second coolant cooled in the first chiller 41 through heat-exchange with the first coolant may cool the battery module 32 to prevent overheating while circulating along the battery coolant line 31.

The first coolant cooled in the radiator 20 may first pass through the first chiller 41 provided on the temperature adjusting module 40 by the operation of the valve module 50, thereby cooling the second coolant rapidly and efficiently.

The second coolant cooled while passing through the first chiller 41 may be supplied to the battery module 32 along the battery coolant line 31, thereby cooling the battery module 32 more efficiently.

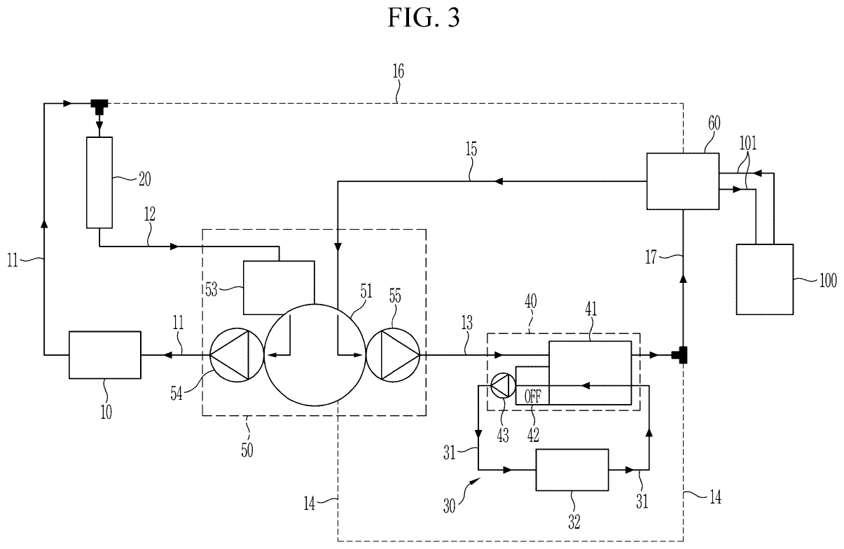

In an embodiment of the present disclosure, an operation in the second mode for cooling the vehicle interior, and for cooling the battery module 32 is described in detail with reference to FIG. 3.

FIG. 3 is an operation diagram according to the second mode in a heat pump system for the vehicle according to an embodiment of the present disclosure.

Referring to FIG. 3, in the second mode, the second line 12 may be connected to the first line 11 by the operation of the valve 51 so that the first coolant cooled in the radiator 20 is supplied to the electrical component 10.

The fifth line 15 may be connected to the third line 13 by the operation of the valve 51.

The seventh line 17 may be opened, so that the third line 13 and the fifth line 15 are connected through the second chiller 60.

The fourth line 14 and the sixth line 16 may be closed by the operation of the valve 51.

Accordingly, the first line 11 and the second line 12 may form an independent closed circuit by the operation of the valve module 50.

In addition, the third line 13, the fifth line 15, and the seventh line 17 may form an independent closed circuit by the operation of the valve module 50.

In the battery cooling apparatus 30, the second coolant may flow along the battery coolant line 31 by the operation of the first water pump 43, and may pass through the first chiller 41.

In such a state, when the second water pump 54 is operated, the first coolant cooled in the radiator 20 may be introduced into the valve 51 along the second line 12, and then discharged through the first line 11.

The first coolant discharged to the first line 11 may cool the electrical component 10 while passing through the electrical component 10. The first coolant having cooled the electrical component 10 may be introduced into the radiator 20 along the second line 12.

In addition, when the third water pump 55 is operated, the first coolant discharged to the third line 13 may pass through the first chiller 41.

The first coolant having passed through the first chiller 41 may flow along the opened seventh line 17. The first coolant flowing through the seventh line 17 may pass through the second chiller 60, and then flow along the fifth line 15.

In other words, the first coolant may flow sequentially along the third line 13, the seventh line 17, the second chiller 60, the fifth line 15, and the valve 51 by the third water pump 55.

The air conditioner unit 100 may operate so that refrigerant is the supplied to the second chiller 60 through the refrigerant connection line 101.

The second chiller 60 may cool the introduced first coolant through heat-exchange with the refrigerant.

The first coolant cooled in the second chiller 60 may be introduced into the valve 51 along the fifth line 15, and may pass through the first chiller 41 along the third line 13, again.

The first coolant may cool the second coolant through heat-exchange with the second coolant passing through the first chiller 41.

The second coolant cooled in the first chiller 41 through heat-exchange with the first coolant may flow along the battery coolant line 31, and the battery module 32 may be efficiently cooled while passing through the battery module 32.

The second coolant having passed through the battery module 32 may pass through the first chiller 41 again along the battery coolant line 31, thereby repeatedly performing the above-described operation.

In other words, in the second mode, the second chiller 60 may cool the first coolant by using the refrigerant supplied from the air conditioner unit 100.

In addition, the first chiller 41 may cool the second coolant by using the first coolant cooled through heat-exchange with the refrigerant, and by using the cooled second coolant, thereby efficiently cooling the battery module 32.

As such, while repeatedly performing the above-described processes, the first coolant cooled in the radiator 20 may efficiently cool the electrical component 10.

In addition, the first chiller 41 may cool the second coolant by heat-exchanging the first coolant cooled through heat-exchange with the refrigerant, with the second coolant in the second chiller 60.

The second coolant cooled while passing through the first chiller 41 may be supplied to the battery module 32 along the battery coolant line 31, thereby cooling the battery module 32 more efficiently.

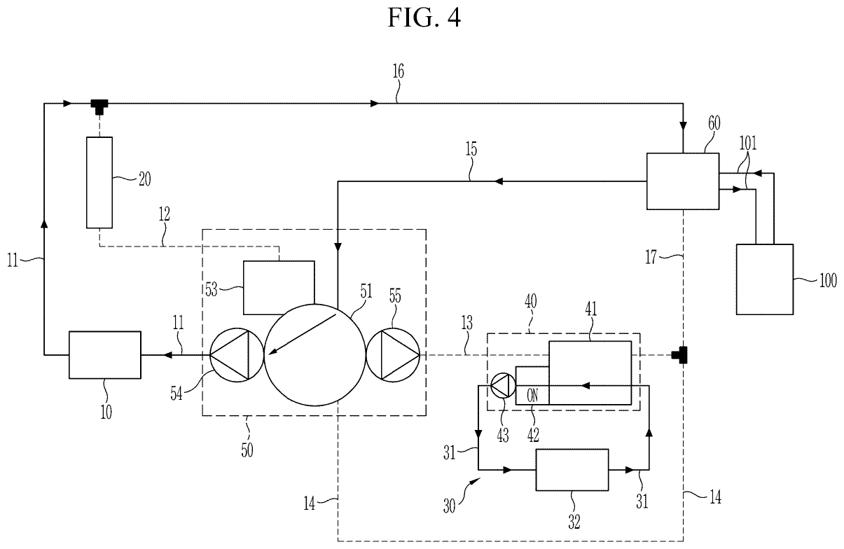

In an embodiment of the present disclosure, an operation in the third mode for heating the vehicle interior and for heating the battery module 32 by using the coolant heater 42 is described in detail with reference to FIG. 4.

FIG. 4 is an operation diagram according to the third mode in a heat pump system for the vehicle according to an embodiment of the present disclosure.

Referring to FIG. 4, the second line 12 may be closed by the operation of the valve 51 so that the first coolant having passed through the electrical component 10 is not supplied to the radiator 20.

The third line 13 and the fourth line 14 may be closed by the operation of the valve 51.

The fifth line 15 may be connected to the first line 11 by the operation of the valve 51.

The sixth line 16 may be opened to be connected to the first line 11 and the fifth line 15. Accordingly, the sixth line 16 may be connected to the first line 11 and the second chiller 60.

The seventh line 17 may be closed by the operation of the valve module 50.

Accordingly, the first line 11, the fifth line 15, and the sixth line 16 may form an independent closed circuit by the operation of the valve module 50.

In the battery cooling apparatus 30, the second coolant may flow along the battery coolant line 31 by the operation of the first water pump 43, to sequentially pass through the first chiller 41 and the coolant heater 42.

In such a state, when the second water pump 54 is operated, the first coolant discharged to the first line 11 may cool the electrical component 10 while passing through the electrical component 10.

The first coolant having cooled the electrical component 10 may flow along the opened sixth line 16. The coolant flowing through the sixth line 16 may pass through the second chiller 60, and then flow along the opened fifth line 15.

The air conditioner unit 100 may operate so that refrigerant is the supplied to the second chiller 60 through the refrigerant connection line 101.

The second chiller 60 may recollect the waste heat of the electrical component 10 from the first coolant whose temperature is increased while cooling the electrical component 10.

The first coolant whose temperature is increased by absorbing the waste heat of the electrical component 10 may be recollected while increasing the temperature of the refrigerant supplied to the second chiller 60, while passing through the second chiller 60.

In other words, in order to recollect the waste heat from the first coolant whose temperature is increased while passing through the electrical component 10, the second chiller 60 may heat-exchange the first coolant and the refrigerant, and may increase the temperature of the refrigerant. The refrigerant whose temperature is increased may be supplied to the air conditioner unit 100.

The coolant heater 42 may be operated in the battery cooling apparatus 30, in order to heat the battery module 32.

The coolant heater 42 may increase the temperature of the second coolant circulating along the battery coolant line 31 by the operation of the first water pump 43, thereby efficiently increasing the temperature of the battery module 32.

As such, while repeatedly performing the above-described processes, the second chiller 60 may smoothly recollect the waste heat of the electrical component 10 from the coolant whose temperature is increased, while cooling the electrical component 10.

In addition, the temperature adjusting module 40 may rapidly heat the second coolant through an operation of the coolant heater 42, and may rapidly heat the battery module 32 by supplying the second coolant whose temperature is increased to the battery module 32.

In other words, in the third mode, the waste heat of the electrical component 10 may be absorbed by the second chiller 60 and may be used to increase the temperature of the refrigerant, thereby reducing the power consumption of the compressor provided in the air conditioner unit 100, and improving the heating efficiency.

In the third mode, by supplying the heated second coolant to the battery module 32 through the operation of the coolant heater 42 and the first water pump 43 by the temperature adjusting module 40, the temperature of the battery module 32 may be increased.

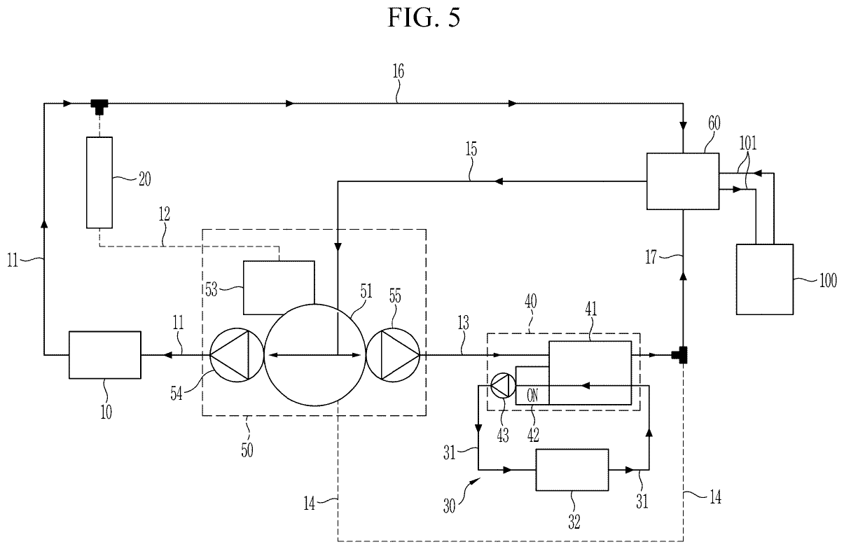

In addition, in an embodiment of the present disclosure, an operation in the fourth mode for heating the vehicle interior, and for heating the battery module 32 by using the second coolant heat-exchanged with the first coolant is described in detail with reference to FIG. 5.

FIG. 5 is an operation diagram according to the fourth mode in a heat pump system for the vehicle according to an embodiment of the present disclosure.

Referring to FIG. 5, the second line 12 may be closed by the operation of the valve 51 so that the first coolant having passed through the electrical component 10 is not supplied to the radiator 20.

The fourth line 14 may be closed by the operation of the valve 51.

The fifth line 15 may be connected to the first line 11 and the third line 13 by the operation of the valve 51, in an interior of the valve 51.

The sixth line 16 may be opened to be connected to the first line 11 and the fifth line 15. Accordingly, the sixth line 16 may be connected to the first line 11 and the second chiller 60.

The seventh line 17 may be opened to be connected to the third line 13 and the fifth line 15.

Accordingly, the first line 11, the third line 13, the fifth line 15, the sixth line 16, and the seventh line 17 may be interconnected by the operation of the valve module 50.

When the second water pump 54 is operated, the first coolant discharged to the first line 11 may cool the electrical component 10 while passing through the electrical component 10.

The first coolant having cooled the electrical component 10 may flow along the opened sixth line 16. The coolant flowing through the sixth line 16 may pass through the second chiller 60, and then flow along the opened fifth line 15.

When the third water pump 55 is operated, the first coolant discharged to the third line 13 may pass through the first chiller 41 of the temperature adjusting module 40.

The first coolant having passed through the first chiller 41 may flow along the opened seventh line 17. The first coolant flowing through the seventh line 17 may pass through the second chiller 60, and then flow along the fifth line 15.

The air conditioner unit 100 may operate so that the refrigerant is supplied to the second chiller 60 through the refrigerant connection line 101.

The second chiller 60 may recollect the waste heat of the electrical component 10 from the first coolant whose temperature is increased while cooling the electrical component 10.

The first coolant whose temperature is increased by absorbing the waste heat of the electrical component 10 may be recollected while increasing the temperature of the refrigerant supplied to the second chiller 60, while passing through the second chiller 60.

In other words, in order to recollect the waste heat from the first coolant whose temperature is increased while passing through the electrical component 10, the second chiller 60 may heat-exchange the first coolant and the refrigerant, and may increase the temperature of the refrigerant. The refrigerant whose temperature is increased may be supplied to the air conditioner unit 100.

A partial first coolant among the first coolant introduced into the valve 51 through the fifth line 15 may flow through the first line 11.

In addition, a remaining first coolant among the first coolant introduced into the valve 51 through the fifth line 15 may flow to the third line 13, thereby repeatedly performing the above-described processes.

In the battery cooling apparatus 30, the second coolant may flow along the battery coolant line 31 by the operation of the first water pump 43, and may sequentially pass through the first chiller 41 and the coolant heater 42.

The temperature adjusting module 40 may heat-exchange the first coolant flowing along the third line 13 with the second coolant flowing along the battery coolant line 31.

Then, the temperature adjusting module 40 may supply the heat-exchanged second coolant to the battery module 32 through the battery coolant line 31.

In other words, the first coolant flowing along the third line 13 among the first coolant heat-exchanged with the refrigerant in the second chiller 60 may increase the temperature of the second coolant through heat-exchange with the second coolant passing through the first chiller 41.

In the first chiller 41, the second coolant whose temperature is increased through heat-exchange with the first coolant may flow along the battery coolant line 31, and the temperature of the battery module 32 may be efficiently increased while passing through the battery module 32.

The second coolant having passed through the battery module 32 may pass through the first chiller 41 again along the battery coolant line 31, thereby repeatedly performing the above-described operation.

In other words, in the fourth mode, the waste heat of the electrical component 10 may be absorbed by the second chiller 60 and may be used to increase the temperature of the refrigerant, thereby reducing the power consumption of the compressor provided in the air conditioner unit 100, and improving the heating efficiency.

In the fourth mode, the first chiller 41 may increase the temperature of the second coolant by heat-exchanging the first coolant whose temperature is increased through heat-exchange with the refrigerant, with the second coolant in the second chiller 60.

The second coolant whose temperature is increased while passing through the first chiller 41 may be supplied to the battery module 32 along the battery coolant line 31, thereby increasing the temperature of the battery module 32 rapidly and efficiently.

Therefore, as described above, when a heat pump system for the vehicle according to an embodiment of the present disclosure is applied, the temperature of the battery module 32 may be adjusted by using the first chiller 41 in which the first coolant as a normal coolant and the second coolant as a low-conductivity coolant having different properties are heat-exchanged with each other, and by employing the separate battery cooling apparatus 30 for circulating the low-conductivity coolant through the high-voltage battery module 32, the fire safety of the battery module 32 may be improved.

In addition, according to the present disclosure, by applying both of the normal coolant for adjusting the temperature of the electrical component 10 and the low-conductivity coolant for adjusting the temperature of the battery module 32, the fire safety of the battery module 32 may be secured, thereby enabling compliance with the coolant regulation and minimizing cost increases.

In addition, according to the present disclosure, a plurality of fluid lines through which the first coolant flows depending on the selected mode of the vehicle may be formed in the single valve, and the components are modularized, thereby achieving streamlining and simplification of the system.

In addition, according to the present disclosure, by efficiently adjusting the temperature of the battery module 32, the optimal performance of the battery module 32 may be obtained, and the overall travel distance of the vehicle may be increased through the efficient management of the battery module 32.

In addition, according to the present disclosure, through streamlining of an entire system, it is possible to reduce manufacturing cost and weight and improve space utilization.

While this disclosure has been described in connection with what is presently considered to be practical embodiments of the present disclosure, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: electrical component
11, 12, 13: first, second, and third line
14, 15, 16: fourth, fifth, and the sixth line
17: seventh line
20: radiator
30: battery cooling apparatus
31: battery coolant line
32: battery module
40: temperature adjusting module
41: first chiller
42: coolant heater
43: first water pump
50: valve module
51: valve
53: reservoir tank
54: second water pump
55: third water pump

What is claimed is:

1. A heat pump system for a vehicle, the heat pump system comprising:
a valve module configured to control a flow rate of a first coolant based on at least one mode for adjusting a temperature of a vehicle interior and for adjusting a temperature of an electrical component and a battery module;
a first line connected to the valve module to selectively allow the first coolant to flow, wherein the electrical component is provided on the first line;
a second line including:
a first end connected to the first line, and
a second end connected to the valve module to selectively allow the first coolant to flow, wherein a radiator is provided on the second line;
a third line connected to the valve module to selectively allow the first coolant to flow, wherein a temperature adjusting module is provided on the third line;
a fourth line including:
a first end connected to the valve module to selectively allow the first coolant to flow, and
a second end connected to the third line;
a fifth line including a first end connected to the valve module to selectively allow the first coolant to flow;
a sixth line including a first end connected to a location where the first line and the second line are connected, the sixth line configured to selectively allow the first coolant to flow;
a seventh line including a first end connected to a location where the third line and the fourth line are connected, the seventh line configured to selectively allow the first coolant to flow; and
a battery cooling apparatus including a battery coolant line having a first end and a second end connected to the temperature adjusting module to allow a second coolant to flow, wherein the battery module is provided on the battery coolant line.

2. The heat pump system of claim 1, wherein the temperature adjusting module comprises:
a first chiller connected to the third line and the battery coolant line to allow the first coolant and the second coolant to flow;
a coolant heater connected to the battery coolant line to allow the second coolant to flow, and configured to selectively heat the second coolant; and
a first water pump provided on the battery coolant line and configured to circulate the second coolant along the battery coolant line.

3. The heat pump system of claim 2, wherein the first chiller, the coolant heater, and the first water pump are integrally configured.

4. The heat pump system of claim 1, wherein the valve module comprises:
a valve configured to control the flow rate of the first coolant; and
at least one water pump provided in the valve.

5. The heat pump system of claim 4, wherein the at least one water pump comprises:
a second water pump mounted on the valve to correspond to the first line; and
a third water pump mounted on the valve to correspond to the third line.

6. The heat pump system of claim 5, wherein the second water pump and the third water pump are disposed at locations facing each other based on the valve.

7. The heat pump system of claim 4, wherein the valve is configured to selectively discharge the first coolant, which is selectively introduced from the second line, the fourth line, or the fifth line, through the first line or the third line, based on the selected at least one mode.

8. The heat pump system of claim 1, wherein:
a second chiller connected to an air conditioner unit through a refrigerant connection line is provided at a second end of the fifth line; and
a second end of the sixth line and a second end of the seventh line are connected to the second chiller, so that the sixth line and the seventh line are connected to the fifth line through the second chiller.

9. The heat pump system of claim 8, wherein the second chiller is a water-cooled heat-exchanger configured to exchange heat between the first coolant and a refrigerant supplied from the air conditioner unit.

10. The heat pump system of claim 1, wherein the at least one mode comprises:
a first mode in which the electrical component is cooled using the first coolant cooled in the radiator and the battery module is cooled;
a second mode in which the vehicle interior and the battery module are cooled;
a third mode in which the vehicle interior is heated and the battery module is heated using a coolant heater; and
a fourth mode in which the vehicle interior is heated and the battery module is heated using the second coolant having exchanged heat with the first coolant.

11. The heat pump system of claim 10, wherein, in the first mode:
the second line is connected to the third line by the valve module so that the first coolant cooled in the radiator is supplied into the electrical component and the temperature adjusting module;
the fourth line is connected to the first line by an operation of the valve module;
the first line, the second line, the third line, and the fourth line are interconnected by the valve module, so that the first coolant circulates along the first line, the second line, the third line, and the fourth line;
the fifth line is configured to be closed by the valve module;
the sixth line and the seventh line are configured to be closed;
the second coolant flows along the battery coolant line by the temperature adjusting module, in the battery cooling apparatus; and
the temperature adjusting module is configured to exchange heat between the first coolant flowing from the radiator along the third line and the second coolant flowing along the battery coolant line, and configured to supply the heat-exchanged second coolant to the battery module through the battery coolant line.

12. The heat pump system of claim 10, wherein, in the second mode:
the second line is connected to the first line by an operation of the valve module so that the first coolant cooled in the radiator is supplied to the electrical component;
the fifth line is connected to the third line by the operation of the valve module;
the seventh line is configured to be opened, so that the third line and the fifth line are connected;
the fourth line is configured to be closed by the operation of the valve module;
the sixth line is configured to be closed;
the first line and the second line are configured to form an independent closed circuit by the valve module;
the third line, the fifth line, and the seventh line are configured to form an independent closed circuit by the operation of the valve module;
the second coolant flows along the battery coolant line by the temperature adjusting module, in the battery cooling apparatus; and
the temperature adjusting module is configured to exchange heat between the first coolant flowing along the third line and the second coolant flowing along the battery coolant line, and configured to supply the heat-exchanged second coolant to the battery module through the battery coolant line.

13. The heat pump system of claim 10, wherein, in the third mode:
the second line is configured to be closed by the valve module so that the first coolant having passed through the electrical component is not supplied to the radiator;
the third line and the fourth line are configured to be closed by the valve module;
the fifth line is configured to be connected to the first line by the valve module;
the sixth line is configured to be opened to be connected to the first line and the fifth line;
the seventh line is configured to be closed;
the first line, the fifth line, and the sixth line are configured to form an independent closed circuit by the valve module;
the second coolant flows along the battery coolant line by the temperature adjusting module, in the battery cooling apparatus; and
the temperature adjusting module is configured to increase the temperature of the second coolant flowing along the battery coolant line, and supply the second coolant whose temperature is increased to the battery module through the battery coolant line.

14. The heat pump system of claim 10, wherein, in the fourth mode:
the second line is configured to be closed by the valve module so that the first coolant having passed through the electrical component is not supplied to the radiator;
the fourth line is configured to be closed by the valve module;
the fifth line is connected to the first line and the third line by the valve module;
the sixth line is configured to be opened to be connected to the first line and the fifth line;
the seventh line is configured to be opened to be connected to the third line and the fifth line;
the first line, the third line, the fifth line, the sixth line, and the seventh line are interconnected by the valve module;
a partial first coolant among the first coolant introduced into the valve module through the fifth line flows to the first line;
a remaining first coolant among the first coolant introduced into the valve module through the fifth line flows to the third line;
the second coolant flows along the battery coolant line by the temperature adjusting module, in the battery cooling apparatus; and
the temperature adjusting module is configured to exchange heat between the first coolant flowing along the third line and the second coolant flowing along the battery coolant line, and configured to supply the heat-exchanged second coolant to the battery module through the battery coolant line.

15. The heat pump system of claim 4, wherein the valve module further comprises a reservoir tank provided in the valve, and connected to the second line.

16. The heat pump system of claim 2, wherein, when the temperature of the battery module is to be increased, the coolant heater is operated to heat the second coolant supplied to the battery module along the battery coolant line.

17. The heat pump system of claim 1, wherein the second coolant is a low-conductivity coolant having low electrical conductivity.
